(19) United States
(12) Patent Application Publication
(10) Pub. No.: US 2017/0092017 A1
(43) Pub. Date: Mar. 30, 2017

(54) PARKING MANAGEMENT DEVICE, PARKING MANAGEMENT METHOD AND SERVER

(71) Applicant: ALi Corporation, Hsinchu (TW)

(72) Inventors: Hua-Cai Zhou, Guangdong (CN); Shuang-Huan Huang, Guangdong (CN); Qiao-Qin Wei, Guangdong (CN); Yan-Wu Wang, Guangdong (CN)

(21) Appl. No.: 14/958,649

(22) Filed: Dec. 3, 2015

(30) Foreign Application Priority Data
Sep. 24, 2015 (CN) 201510615045.4

(51) Int. Cl. G07B 15/02

(52) U.S. Cl. CPC G07B 15/02

(57) ABSTRACT

A parking management device, a parking management method and a server are provided. The parking management device includes an identification device and a processor. The identification device identifies vehicle information of a vehicle. The processor receives the vehicle information from the identification device, and determines whether to obtain driver information corresponding to the vehicle information from a database, where the driver information includes a parking reputation value. The processor obtains a score value according to a parking status of the vehicle. The processor updates the parking reputation value according to the score value, and calculates a parking fee according to the score value and the parking reputation value.

### CROSS-REFERENCE TO RELATED APPLICATION

This application claims the priority benefit of China application serial no. 201510615045.4, filed on Sep. 24, 2015. The entirety of the above-mentioned patent application is hereby incorporated by reference herein and made a part of this specification.

### BACKGROUND OF THE INVENTION

Field of the Invention

The invention relates to a management device, a management method and a server, and particularly relates to a parking management device, a parking management method and a server.

Description of Related Art

Along with development of technology and enhancement of people's quality of life, the proportion of people owning cars becomes higher and higher. Under this situation, parking spaces of a parking lot become more precious. Even so, many drivers do not park their cars by following rules of the parking lot due to lack of civic morality, which increases difficulty for others to find a parking space. For example, when a driver does not accurately park a vehicle in the parking space, a part of the vehicle located out of a range the parking space probably occupies one or a plurality of neighbouring parking spaces, such that other drivers cannot use these occupied parking spaces. Therefore, how to resolve the parking inconvenience caused by the aforementioned uncivilized parking phenomenon is a direction of effort for people in the art.

### SUMMARY OF THE INVENTION

The invention is directed to a parking management apparatus, a parking management method and a server. The method provided by the invention is able to adjust a parking fee according to a parking status of a vehicle, so as to make the driver to park more carefully.

The invention provides a parking management device, which is adapted to manage a plurality of parking spaces. The parking management device includes an identification device and a processor. The identification device identifies vehicle information of a vehicle. The processor is coupled to the identification device. The processor receives the vehicle information from the identification device, and determines whether to obtain driver information corresponding to the vehicle information from a database, where the driver information includes a parking reputation value. The processor obtains a score value according to a parking status of the vehicle. The processor updates the parking reputation value according to the score value, and calculates a parking fee according to the score value and the parking reputation value.

The invention provides a parking management method, which is adapted for a parking management device to manage a plurality of parking spaces. The parking management method includes following steps. Vehicle information of a vehicle is identified. It is determined whether to obtain driver information corresponding to the vehicle information from a database, where the driver information includes a parking reputation value. A score is given according to a parking status of the vehicle to obtain a score value. The parking reputation value is updated according to the score value, and a parking fee is calculated according to the score value and the parking reputation value.

The invention provides a server including a processor and a storage medium. The storage medium is coupled to the processor. The storage medium stores a database, and the database includes a plurality of driver information, where the driver information includes vehicle information and parking reputation values. The processor receives the vehicle information through a network connection, and determines the driver information complying with the vehicle information according to the vehicle information, and transmits back the driver information. When the processor receives the updated parking reputation value in response to the driver information, the processor stores the updated parking reputation value corresponding to the driver information.

According to the above descriptions, the method provided by the invention may adopt the parking reputation value to represent historic parking statuses of the vehicle in the database, and may adjust a parking fee by determining a current parking status.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a functional block diagram of a parking management device according to an embodiment of the invention.

FIG. 1B is a functional block diagram of a parking management device according to an embodiment of the invention.

FIG. 2 is a flowchart illustrating a parking management method according to an embodiment of the invention.

FIG. 3 illustrates a parking status scoring mechanism according to an embodiment of the invention.

FIG. 4 is a functional block diagram of a server according to an embodiment of the invention.

### DESCRIPTION OF EMBODIMENTS

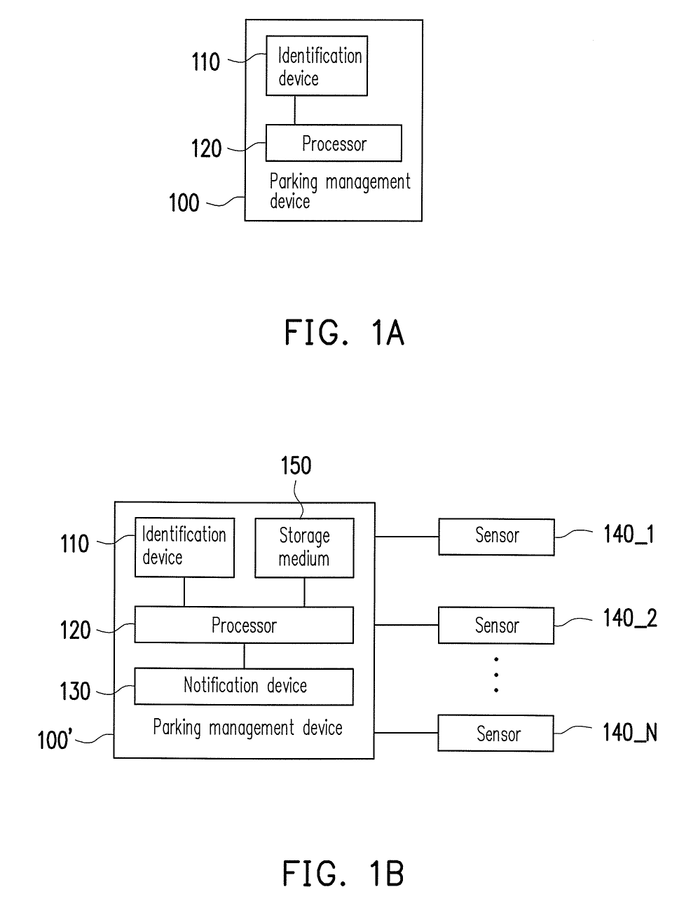

Referring to FIG. 1A, the parking management device 100 is, for example, a monitor or a monitoring system set up in a parking lot, a roadside parking space, or a place capable of monitoring any parking space/non-parking space, though the invention is not limited thereto. The parking management device 100 may include an identification device 110 and a processor 120. The identification device 110 is, for example, any image capturing device having a charge coupled device (CCD) lens, a complementary metal oxide semiconductor transistors (CMOS) lens or an infrared lens, or is an image capturing device capable of obtaining depth information, for example, a depth camera or a three-dimensional (3D) camera, etc. In other embodiments, the identification device 110 can also be a radio-frequency identification (RFID) reader or other similar non-contact tag reader, which is used for reading RFID tags installed on vehicles.

The processor 120 is coupled to the identification device 110. The processor 120 can be a general purpose processor, a special purpose processor, a conventional processor, a digital signal processor, a plurality of microprocessors, one or a plurality of microprocessors combined with a digital signal processor core, a controller, a micro controller, an application specific integrated circuit (ASIC), a field programmable gate array (FPGA), any other type of an integrated circuit, a state machine, a processor based on advanced RISC machine (ARM) and similar product.

Referring to FIG. 1B, in the parking management device 100′ of the present embodiment, the processor 120 may access program codes and/or software modules stored in a storage medium 150 of the parking management device 100′ to implement a parking management method of the invention. The storage medium 150 is, for example, any type of a fixed or movable random access memory (RAM), a read-only memory (ROM), a flash memory, a hard disk drive or other similar device or a combination of the above devices, which is not limited by the invention.

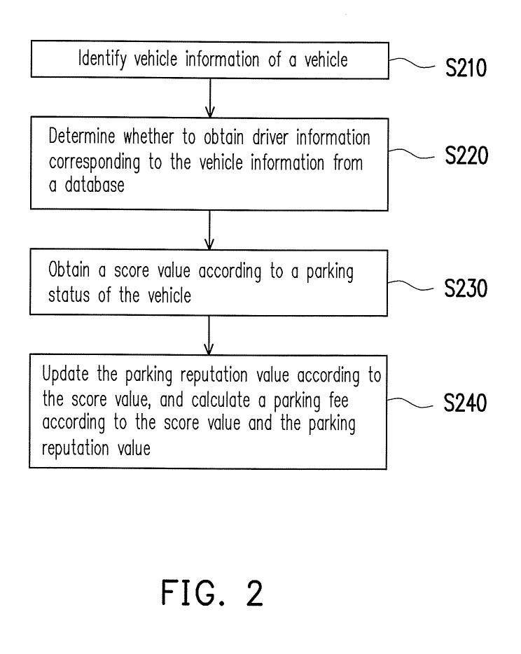

Referring to FIG. 2, the parking management method of the present embodiment can be executed by the parking management device 100′ of FIG. 1B, and detailed steps of the parking management method of the present embodiment are described below with reference of various components of FIG. 1B.

First, in step S210, the identification device 110 identifies vehicle information of a vehicle. In an embodiment, the parking management device 100′ can be deployed at an entrance of a parking lot, and is used for monitoring vehicles entering (or leaving) the parking lot. In the present embodiment, the identification device 110 may, for example, identify a licence plate image of the vehicle located within a monitoring range thereof (for example, the vehicle preparing to enter the parking lot) to obtain the vehicle information (for example, a licence plate number). In other embodiments, when the vehicle is installed with an RFID tag, the identification device 110 can be implemented by the aforementioned non-contact tag reader to read the RFID tag to obtain the vehicle information of the vehicle (for example, a unique identification (UID) of the vehicle). After obtaining the vehicle information of the vehicle, the identification device 110 may transmit the vehicle information to the processor 120.

Then, in step S220, the processor 120 determines whether to obtain driver information corresponding to the vehicle information from a database. In an embodiment, the processor 120 may search the database according to the vehicle information (for example, the licence plate number or the UID) to determine whether the driver information complied with the vehicle information exists. The database can be a list stored in the storage medium 150 of the parking management device 100′, which records various vehicle information and the corresponding driver information. In other embodiments, the database can also be stored in a server (for example, a cloud server or a similar network server), and the processor 120 may access the database through a network connection between the processor 120 and the server, which is not limited thereto.

In an embodiment, the driver information is, for example, a parking reputation value of the driver of the vehicle. The parking reputation value, for example, relates to score values of past parking behaviours of the driver. It is assumed that the driver has ever not accurately parked the vehicle in the parking space which results in a fact of occupying a parking space of other driver, the score value is probably decreased to a lower value by other parking management device managing the related parking space. Conversely, if the driver can accurately park the vehicle in the parking spaces each time in the past, such score value can be maintained or increased to a higher value by other parking management devices managing the related parking spaces, though implementation of the embodiment is not limited thereto.

In other embodiments, after obtaining the driver information corresponding to the vehicle information, the processor 120 may determine whether the driver information is included in a blacklist. The blacklist is, for example, a list recording the drivers with the parking reputation values lower than a predetermined value, though the invention is not limited thereto. In this case, when the processor 120 determines that the driver information is recorded in the blacklist, the processor 120 may transmit a control signal to prohibit the vehicle from entering the parking space. For example, the processor 120 may send a control signal to a gate controller located at the entrance of the parking lot, and controls the gate controller to reject the vehicle from entering the parking lot, though the invention is not limited thereto.

After the step S220, in step S230, the processor 120 obtains s a score value according to a parking status of the vehicle. In the present embodiment, the parking management device 100′ is further coupled to sensors 140_1-140_N (where N is a positive integer), and the processor 120 may determine the parking status of the vehicle according to information transmitted by the sensors 140_1-140_N. In an embodiment, the sensors 140_1-140_N (for example, infrared transceivers) can be deployed around the parking space for detecting a relative position between the vehicle and the parking space to generate sensing information. For example, the sensors 140_1-140_N may send infrared signals to the parking space, and the parking status of the vehicle (for example, whether the vehicle is accurately parked in the parking space) is determined according to a blocking status of the infrared signals. In other embodiments, the sensors 140_1-140_N can be implemented by pressure sensors installed on the ground of the parking space, such that the processor 120 may determine whether the vehicle simultaneously occupies two or more parking spaces. Alternatively, the sensors 140_1-140_N can be installed at different areas of a single parking space, such that the processor 120 may determine the parking status of the vehicle according to a weight distribution status of the vehicle.

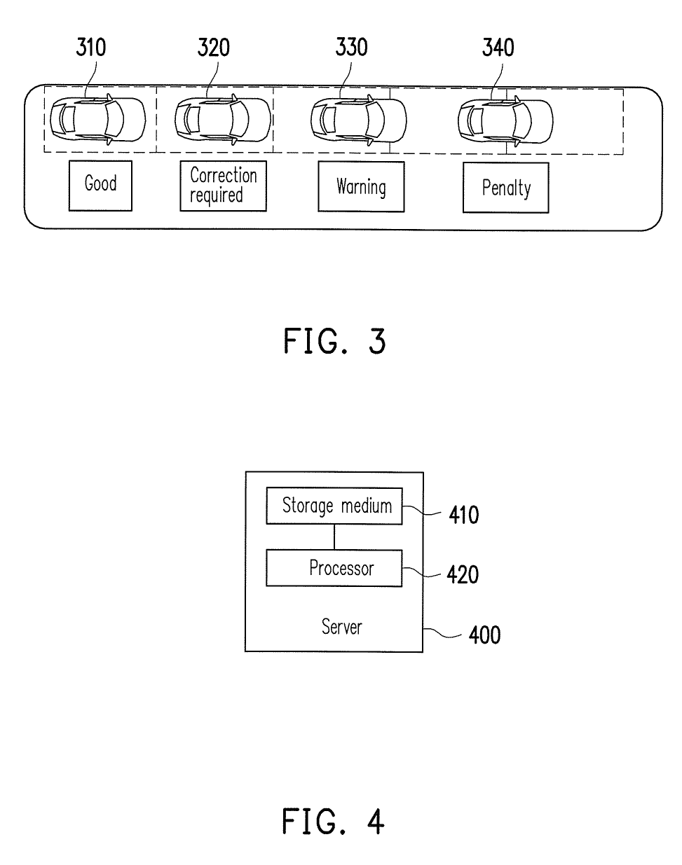

After obtaining the parking status of the vehicle, the processor 120 may obtain a score value according to the parking status of the vehicle. Referring to FIG. 3, since a vehicle 310 is accurately parked in the parking space thereof, the processor 120 may give a higher score value (for example, a score of 100) to the vehicle 310. Moreover, although the vehicle 320 does not exceed its parking space, since a front part of the vehicle is rather close to an edge of the parking space, the processor 120 gives a score value slightly lower than that of the vehicle 310 (for example, a score of 75) to the vehicle 320. Regarding a vehicle 330, since it has exceeded its parking space and occupies another parking space, which may make other vehicle unable to park in the another parking space. In this case, the processor 120 may give a lower score value (for example, a score of 50) to the vehicle 330. Regarding a vehicle 340, since it has severely occupied the neighboring parking space, the processor 120 may give a score value lower than that of the vehicle 330 to the vehicle 340 (for example, a score of 25). Those skilled in the art should understand that the aforementioned score values are only used as an example, and are not used for limiting the implementation of the invention.

In other embodiments, the score values can be characterized as several different grades. Taking FIG. 3 as an example, the grades corresponding to the parking status of the vehicles 310-330 can be respectively “good”, “correction required” and “warning”. Moreover, since the vehicle 340 is regarded to occupy two parking spaces, the parking status of the vehicle may correspond to “penalty”. In another embodiment, the parking management device 100′ may further notify the drivers of the vehicles 310-340 through a notification device 130 coupled to the processor 120, such that the drivers may have a chance to correct the parking status. The notification device 130, for example, includes a loudspeaker, a flashlight and/or a projection unit for sending a corresponding voice notification, a flash notification and/or a projection notification to notify the drivers of the vehicles 310-340 to correct/maintain the parking status.

In an embodiment, if the vehicle 340 with the poor parking status takes no notice of the aforementioned notification to correct the parking status thereof, besides that the processor 120 may give a low score value to the vehicle 340, the vehicle can be charged with an extra fee for penalty when the parking fee thereof is calculated. Further, the processor 120 may actively call the police for the parking status of the vehicle 340, and the police may take measures of towing the vehicle 340 or giving a ticket to the vehicle 340.

In step S240, the processor 120 updates the parking reputation value according to the score value, and calculates a parking fee according to the score value and the parking reputation value. In an embodiment, when the score value is lower than a first predetermined value (for example, 60), the processor 120 may decrease the parking reputation value. Namely, if the parking status of the vehicle is poor, the processor 120 may record such situation by decreasing the parking reputation value of the driver. Moreover, when the parking reputation value is lower than a second predetermined value (for example, 50), the processor may increase the parking fee. In other words, when the historic parking statuses of the vehicle are all poor, and the parking reputation value is decreased to be lower than the second predetermined value, the current parking fee is increased. Moreover, in case of the aforementioned situation of “penalty”, the processor 120 may additionally charge a fee to the vehicle to serve as penalty for the poor parking status.

On the other hand, if the parking status of the vehicle is good (for example, the score value is not lower than the first predetermined value), the processor 120 may correspondingly increase the parking reputation value thereof. When the parking reputation value is not lower than the second predetermined value, the processor 120 may relatively decrease the parking fee (for example, give a discount or a free charge, etc.) to reward the good parking behaviour of the driver.

Referring to FIG. 4, in the present embodiment, the server 400 includes a storage medium 410 and a processor 420, and a possible implementation method thereof may refer to related descriptions of the storage medium (not shown) and the processor 120 of the parking management device 100′, which is not repeated.

In the present embodiment, the storage medium 410 may store a database, which includes a plurality of driver information (for example, the vehicle information and the parking reputation values). Moreover, the processor 420 may receive vehicle information identified by the parking management device through a network connection, and determines corresponding driver information according to the vehicle information, and transmits back the driver information to the parking management device. Then, when the processor 420 receives the updated parking reputation value in response to the driver information, the processor 420 stores the updated parking reputation value corresponding to the driver information. Details of the aforementioned operations may refer to the instructions of the aforementioned embodiment, and details thereof are not repeated.

In summary, the invention provides a parking management device, a parking management method and a server. The method provided by the invention may adopt the parking reputation value to represent historic parking statuses of the vehicle in the database, and may adjust a parking fee by determining a current parking status. In this way, in order to avoid paying an extra fee for parking, the drivers have to be careful during parking, such that the uncivilized parking phenomenon in the parking lot could be reduced. Moreover, the parking lot practitioner may also provide a lower parking fee to the drivers with a good parking reputation value by setting the parking management device of the invention, so as to attract more drivers with a good parking behaviour to come.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A parking management device, adapted to manage a plurality of parking spaces, the parking management device comprising:
an identification device, identifying vehicle information of a vehicle; and
a processor, coupled to the identification device,
wherein the processor receives the vehicle information from the identification device, and determines whether to obtain driver information corresponding to the vehicle information from a database, wherein the driver information comprises a parking reputation value,
the processor obtain a score value according to a parking status of the vehicle, and
the processor updates the parking reputation value according to the score value, and calculates a parking fee according to the score value and the parking reputation value.

2. The parking management device as claimed in claim 1, wherein the identification device comprises:
an image capturing device, capturing a license plate image,
wherein the identification device identifies the license plate image to obtain the vehicle information.

3. The parking management device as claimed in claim 1, wherein the identification device comprises:
a non-contact tag reader, reading a radio-frequency identification tag of the vehicle to obtain the vehicle information.

4. The parking management device as claimed in claim 1, wherein when the score value is lower than a first predetermined value, the processor decreases the parking reputation value, and when the parking reputation value is lower than a second predetermined value, the processor increases the parking fee.

5. The parking management device as claimed in claim 1, wherein the processor determines whether the driver information is included in a blacklist after obtaining the driver information corresponding to the vehicle information from the database, and the processor transmits a control signal to prohibit the vehicle from entering one of the parking spaces when determining that the driver information is included in the blacklist.

6. The parking management device as claimed in claim 1, wherein the parking management device is further coupled to:
at least one sensor, disposed around each of the parking spaces, wherein the at least one sensor detects a relative position between the vehicle and the parking space to generate sensing information, and the processor determines the parking status of the vehicle according to the sensing information.

7. The parking management device as claimed in claim 6, further comprising:
a notification device, coupled to the processor, wherein the processor controls the notification device to send a notification according to the parking status.

8. The parking management device as claimed in claim 7, wherein the notification device comprises a loudspeaker, a flashlight and/or a projection unit, and the notification comprises a voice notification, a flash notification and/or a projection notification.

9. The parking management device as claimed in claim 1, wherein the database is stored in a server, and the processor is connected to the server through a network connection, so as to obtain the driver information corresponding to the vehicle information from the database.

10. A parking management method, adapted for a parking management device to manage a plurality of parking spaces, the parking management method comprising:
identifying vehicle information of a vehicle;
determining whether to obtain driver information corresponding to the vehicle information from a database, wherein the driver information comprises a parking reputation value;
obtaining a score value according to a parking status of the vehicle; and
updating the parking reputation value according to the score value, and calculating a parking fee according to the score value and the parking reputation value.

11. The parking management method as claimed in claim 10, wherein the step of updating the parking reputation value according to the score value comprises:
decreasing the parking reputation value when the score value is lower than a first predetermined value, and
the step of calculating the parking fee according to the score value and the parking reputation value comprises:
increasing the parking fee when the parking reputation value is lower than a second predetermined value.

12. The parking management method as claimed in claim 10, wherein after the step of obtaining the driver information corresponding to the vehicle information from the database, the method further comprises:
determining whether the driver information is included in a blacklist; and
prohibiting the vehicle from entering one of the parking spaces when it is determined that the driver information is included in the blacklist.

13. The parking management method as claimed in claim 10, wherein the step of giving the score according to the parking status of the vehicle to obtain the score value comprises:
detecting a relative position between the vehicle and the parking space by at least one sensor disposed around each of the parking spaces, so as to generate sensing information; and
determining the parking status of the vehicle according to the sensing information.

14. The parking management method as claimed in claim 13, wherein after the step of determining the parking status of the vehicle according to the sensing information, the parking management method comprises:
sending a notification according to the parking status.

15. A server, comprising:
a processor; and
a non-transitory storage medium, coupled to the processor,
wherein the non-transitory storage medium stores a database, and the database comprises a plurality of driver information, wherein the driver information comprises vehicle information and parking reputation values,
wherein the processor receives the vehicle information through a network connection, and determines the driver information complying with the vehicle information according to the vehicle information, and transmits back the driver information,
when the processor receives the updated parking reputation value in response to the driver information, the processor stores the updated parking reputation value corresponding to the driver information.
